(19) United States
(12) Patent Application Publication
(10) Pub. No.: US 2026/0010975 A1
(43) Pub. Date: Jan. 8, 2026

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: PANASONIC INTELLECTUAL PROPERTY MANAGEMENT CO., LTD., Osaka (JP)

(72) Inventors: Seigo ENOMOTO, Kyoto (JP); Tadamasa TOMA, Osaka (JP); Yoshihiko MATSUKAWA, Nara (JP); Seikou ABE, Osaka (JP)

(73) Assignee: PANASONIC INTELLECTUAL PROPERTY MANAGEMENT CO., LTD., Osaka (JP)

(21) Appl. No.: 19/325,005

(22) Filed: Sep. 10, 2025

Related U.S. Application Data
(63) Continuation of application No. PCT/JP2024/009066, filed on Mar. 8, 2024.
(60) Provisional application No. 63/452,559, filed on Mar. 16, 2023.

(30) Foreign Application Priority Data
Jan. 30, 2024 (JP) 2024-012183

(51) Int. Cl. G06T 3/40; G06F 3/01; G06F 3/14

(52) U.S. Cl. CPC G06T 3/40; G06F 3/012; G06F 3/14

(57) ABSTRACT

A work terminal acquires a moving image captured at a work site from a camera, receives assistance information required for assisting work performed by a worker at the work site, from an assistance terminal used by an assisting person who assists the work, displays the received assistance information and the acquired moving image on a display part, acquires an amount of change in the motion of the worker from the sensor, and, if the amount of change is greater than or equal to a threshold value, enlarges the moving image being displayed.

### FIELD OF INVENTION

The present disclosure relates to a technique for displaying a moving image captured at a work site.

### BACKGROUND ART

For example, Patent Literature 1 discloses that an information processing device used by a worker inputs an image of a work target, transmits the input image to another information processing device used by an assisting person who assists the work by the worker, receives a feature quantity related to a portion designated by the other information processing device with respect to a first image transmitted in the past to the other information processing device, calculates a similarity between the feature quantity related to the input image and the received feature quantity, and performs predetermined output in a case where the similarity is a first threshold value or more.

However, in the conventional technique described above, when the worker receives work assistance from the assisting person, there is a possibility that it becomes difficult for the worker to recognize which part of the work site the camera is capturing, and further improvement is required.
Patent Literature 1: JP 2016-224889 A

### SUMMARY OF THE INVENTION

The present disclosure has been made to solve the above problems, and an object of the present disclosure is to provide a technique capable of causing a worker to recognize a portion captured by a camera when the worker receives work assistance from an assisting person.

An information processing method according to the present disclosure is an information processing method executed by a computer, the information processing method including: acquiring a moving image captured at a work site from a camera; receiving assistance information necessary for supporting work performed by a worker at the work site from an assistance terminal used by an assisting person who assists the work; displaying the received assistance information and the acquired moving image on a display part; acquiring an amount of change in motion of the worker from a sensor; and enlarging the displayed moving image in a case where the amount of change is equal to or larger than a threshold value.

According to the present disclosure, when a worker receives work assistance from an assisting person, the worker can be made to recognize a portion captured by a camera.

### BRIEF DESCRIPTION OF THE DRAWINGS

FIG. 1 is a diagram illustrating a configuration of a work assistance system according to a present embodiment.

FIG. 2 is a flowchart for explaining work assistance processing by a work terminal according to the embodiment of the present disclosure.

FIG. 3 is a flowchart for explaining work assistance processing by a server according to the embodiment of the present disclosure.

FIG. 4 is a flowchart for explaining work assistance processing by an assistance terminal according to the embodiment of the present disclosure.

FIG. 5 is a diagram illustrating an example of a screen displayed on a display part of the assistance terminal in the present embodiment.

FIG. 6 is a diagram illustrating an example of a screen displayed on a display part of a work terminal in a case where a still image is received in the present embodiment.

FIG. 7 is a diagram illustrating an example of a screen displayed on the display part of the work terminal in a case where it is determined that the amount of change in motion of the worker is equal to or larger than a threshold value in the present embodiment.

### DETAILED DESCRIPTION

### (Knowledge Underlying Present Disclosure)

In the manufacturing industry or the construction industry, a worker who works at a work site may receive work assistance from an assisting person in a remote place different from the work site. In this case, the work terminal used by the worker transmits the moving image captured at the work site by the camera and a first voice collected at the work site by a microphone to the assistance terminal used by the assisting person. The assistance terminal displays the received moving image and outputs the received first voice. Then, the assistance terminal transmits the assistance information necessary for supporting the work and a second voice collected at the remote place by the microphone to the work terminal. The work terminal displays the received assistance information and outputs the received second voice. The worker receives work assistance from the assisting person by viewing the assistance information displayed on the work terminal and listening to the voice of the assisting person included in the second voice.

At this time, the work terminal displays the assistance information received from the assistance terminal and the moving image captured by the camera. In a case where the assistance information is displayed larger than the moving image in order to make it easier for the worker to see, there is a possibility that the worker cannot accurately recognize which part of the work site the camera is capturing even if the worker views the moving image. Therefore, even if the worker is instructed by the assisting person to take a picture of a desired portion, the worker may not be able to photograph the portion.

In Patent Literature 1 described above, the worker terminal searches for a portion of interest to which a marker is added by the assisting person from the moving image currently input, and superimposes the marker indicating the portion of interest on the moving image to be output in a case where the portion of interest is searched for. In Patent Literature 1, since the moving image is displayed on the entire display screen, it is not considered that the assistance information from the assisting person is displayed larger than the moving image.

In order to solve the above problem, the following technique is disclosed.

(1) An information processing method according to one aspect of the present disclosure is an information processing method executed by a computer, the information processing method including: acquiring a moving image captured at a work site from a camera; receiving assistance information necessary for supporting work performed by a worker at the work site from an assistance terminal used by an assisting person who assists the work; displaying the received assistance information and the acquired moving image on a display part; acquiring an amount of change in motion of the worker from a sensor; and enlarging the displayed moving image in a case where the amount of change is equal to or larger than a threshold value.

According to this configuration, the assistance information necessary for supporting the work performed by the worker at the work site and the moving image acquired from the camera are displayed on the display part, and in a case where the worker makes a motion to search for a portion captured by the camera, the displayed moving image is enlarged. Therefore, when the worker receives the work assistance from the assisting person, it is possible to cause the worker to recognize the portion captured by the camera.

(2) The information processing method according to (1) may further include transmitting the acquired moving image to the assistance terminal, in which the assistance information may be a still image extracted by the assisting person from the moving image in the assistance terminal.

According to this configuration, since the still image extracted by the assisting person from the moving image is presented to the worker, the worker can receive work assistance from the assisting person while viewing the still image.

(3) In the information processing method according to (1), the assistance information may be drawing data of a work target.

According to this configuration, since the drawing data of the work target is presented to the worker, the worker can receive work assistance from the assisting person while viewing the drawing data of the work target.

(4) In the information processing method according to (1), the assistance information may be operation manual data indicating an operation method of a work target.

According to this configuration, since the operation manual data indicating the operation method of the work target is presented to the worker, the worker can receive the work assistance by the assisting person while viewing the operation manual data.

(5) In the information processing method according to (1), the assistance information may be an image of an entire screen displayed on a display part of the assistance terminal.

According to this configuration, the image of the entire screen displayed on the display part of the assistance terminal is presented to the worker. In this case, the assisting person may display information necessary for supporting the work on the display part of the assistance terminal and create an image obtained by copying the entire screen. Therefore, the worker can receive the work assistance by the assisting person while viewing the image of the entire screen displayed on the display part of the assistance terminal.

(6) The information processing method according to any one of (1) to (5) may further include returning a size of the displayed moving image to an original size in a case where the amount of change becomes smaller than the threshold value after the moving image is enlarged.

According to this configuration, in a case where the worker recognizes a portion captured by the camera, the size of the enlarged moving image returns to the original size, so that the assisting person can support the work while confirming the moving image.

(7) In the information processing method according to any one of (1) to (6), in which the amount of change may be at least one of a first angular velocity about an X axis indicating a front-back direction of the worker, a second angular velocity about a Y axis indicating a left-right direction of the worker, and a third angular velocity about a Z axis indicating an up-down direction of the worker.

According to this configuration, at least one of the first angular velocity about the X axis indicating the front-back direction of the worker, the second angular velocity about the Y axis indicating the left-right direction of the worker, and the third angular velocity about the Z axis indicating the up-down direction of the worker is acquired from the sensor, and thus, it is possible to detect the motion of the worker such as searching for the portion being captured by the camera.

(8) In the information processing method according to any one of (1) to (6), in which the amount of change may be at least one of a first angular velocity about an X axis indicating a front-back direction of the worker, a second angular velocity about a Y axis indicating a left-right direction of the worker, a third angular velocity about a Z axis indicating an up-down direction of the worker, a first acceleration in the X-axis direction, a second acceleration in the Y-axis direction, and a third acceleration in the Z-axis direction.

According to this configuration, at least one of the first angular velocity about the X axis indicating the front-back direction of the worker, the second angular velocity about the Y axis indicating the left-right direction of the worker, the third angular velocity about the Z axis indicating the up-down direction of the worker, the first acceleration in the X-axis direction, the second acceleration in the Y-axis direction, and the third acceleration in the Z-axis direction is acquired from the sensor, and thus, it is possible to detect the motion of the worker such as searching for the place where the camera is photographing with higher accuracy.

(9) In the information processing method according to (8), in which enlarging the moving image may include enlarging the displayed moving image to a first size in a case where at least one of the first angular velocity, the second angular velocity, and the third angular velocity is equal to or larger than a first threshold value and the first acceleration, the second acceleration, and the third acceleration are smaller than a second threshold value, and enlarging the displayed moving image to a second size larger than the first size in a case where at least one of the first angular velocity, the second angular velocity, and the third angular velocity is equal to or larger than the first threshold value and at least one of the first acceleration, the second acceleration, and the third acceleration is equal to or larger than the second threshold value.

In a case where the worker moves the work terminal in the direction around the X axis, the direction around the Y axis, or the direction around the Z axis without knowing the portion photographed by the camera, at least one of the first angular velocity, the second angular velocity, and the third angular velocity changes largely, but the first acceleration, the second acceleration, and the third acceleration do not change substantially. On the other hand, only in a case where the worker moves the work terminal in the direction around the X axis, the Y axis, or the Z axis, the place where the camera is capturing an image is not known. Further, in a case where the worker moves the work terminal in the direction of the X axis, the Y axis, or the Z axis, at least one of the first angular velocity, the second angular velocity, and the third angular velocity changes greatly, and at least one of the first acceleration, the second acceleration, and the third acceleration also changes greatly. As described above, by changing the size of the moving image to be displayed according to the motion of the worker, it is possible to present the portion captured by the camera to the worker in an easy-to-understand manner.

(10) In the information processing method according to any one of (1) to (6), in which enlarging the moving image may include changing a size of the displayed moving image according to a magnitude of a difference value between the amount of change and a threshold value in a case where the amount of change is equal to or larger than the threshold value.

According to this configuration, the size of the displayed moving image increases as the difference value between the amount of change and the threshold value increases. Therefore, by changing the size of the moving image to be displayed in stages according to the motion of the worker, it is possible to present a portion captured by the camera to the worker in an easy-to-understand manner.

(11) In the information processing method according to any one of (1) to (10), in which the camera and the sensor may be mounted on a head of the worker.

According to this configuration, it is possible to capture a moving image from the viewpoint of the worker, and it is possible to detect the motion of the worker looking around in order to search for a portion captured by the camera by measuring the amount of change in motion of the head of the worker.

The present disclosure can be implemented not only as an information processing method for executing the characteristic processing as described above, but also as an information processing device or the like having a characteristic configuration corresponding to characteristic processing executed by the information processing method. The present disclosure can also be implemented as a computer program that causes a computer to execute characteristic processing included in the information processing method described above. Therefore, an effect similar to the effect in the above information processing method can also be achieved by another aspect described below.

(12) An information processing device according to another aspect of the present disclosure includes: a communication part; and a controller, in which the controller acquires a moving image captured at a work site from a camera, the communication part receives assistance information necessary for assisting work performed by a worker at the work site from an assistance terminal used by an assisting person who assists the work, the controller displays the received assistance information and the acquired moving image on a display part, the controller acquires an amount of change in motion of the worker from a sensor, and the controller enlarges the displayed moving image in a case where the amount of change is equal to or larger than a threshold value.

(13) An information processing program according to another aspect of the present disclosure causes a computer to execute: acquiring a moving image captured at a work site from a camera, receiving assistance information necessary for assisting work performed by a worker at the work site from an assistance terminal used by an assisting person who assists the work, displaying the received assistance information and the acquired moving image on a display part, acquiring an amount of change in motion of the worker from a sensor, and enlarging the displayed moving image in a case where the amount of change is equal to or larger than a threshold value.

(14) A non-transitory computer-readable recording medium according to another aspect of the present disclosure has recorded therein an information processing program, in which the information processing program causes the computer to execute: acquiring a moving image captured at a work site from a camera, receiving assistance information necessary for assisting work performed by a worker at the work site from an assistance terminal used by an assisting person who assists the work, displaying the received assistance information and the acquired moving image on a display part, acquiring an amount of change in motion of the worker from a sensor, and enlarging the displayed moving image in a case where the amount of change is equal to or larger than a threshold value.

Hereinafter, embodiments of the present disclosure will be described with reference to the accompanying drawings. Each of embodiments described below illustrates a specific example of the present disclosure. Numerical values, shapes, constituent elements, steps, order of steps, and the like of the embodiment below are merely examples, and are not intended to limit the present disclosure. A constituent element not described in an independent claim representing a highest concept among constituent elements in the embodiments below is described as an optional constituent element. In all the embodiments, respective contents can be combined.

### EMBODIMENTS

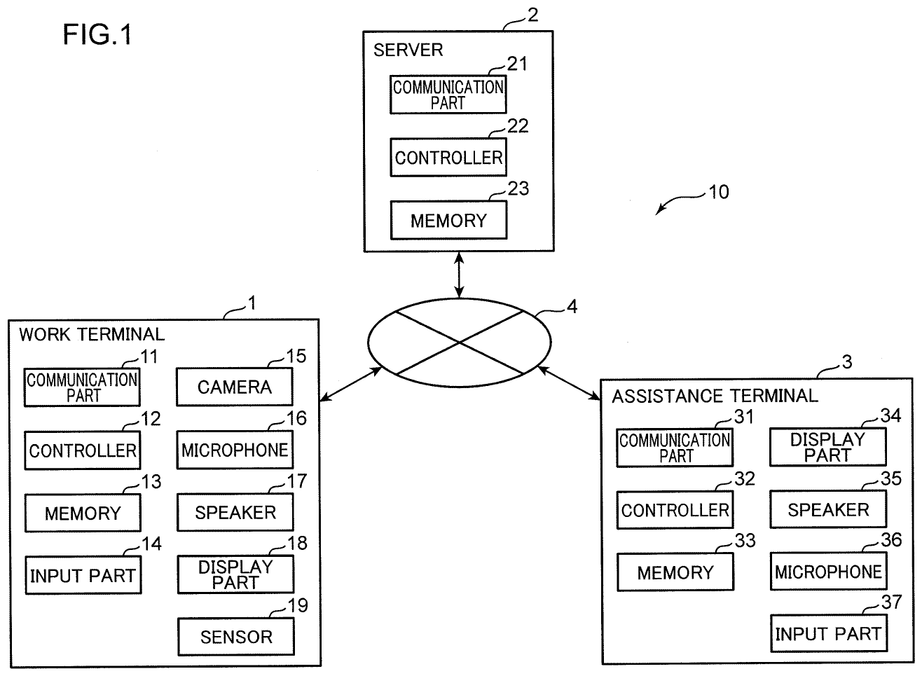

FIG. 1 is a diagram illustrating a configuration of a work assistance system 10 according to the present embodiment.

The work assistance system 10 illustrated in FIG. 1 includes a work terminal 1, a server 2, and an assistance terminal 3.

In the present embodiment, a worker who performs work is at a work site, and an assisting person who assists the work of the worker is at a remote place. The work terminal 1 is used by a worker, and the assistance terminal 3 is used by an assisting person.

The work terminal 1 is, for example, a wearable device worn on the head of the worker. The worker performs work in a state of wearing the work terminal 1 at the work site. The work terminal 1 may be, for example, a smartphone or a tablet computer.

The work terminal 1 includes at least a computer system including, for example, a control program, a processing circuit such as a processor or a logic circuit that executes the control program, and a recording device such as an internal memory or an accessible external memory that stores the control program. Note that the work terminal 1 may be implemented by, for example, hardware implementation by a processing circuit, execution of a software program held in a memory by the processing circuit or distributed from an external server, or a combination of the hardware implementation and the software implementation.

The work terminal 1 is communicably connected to the server 2 via a network 4. The network 4 is the Internet, for example.

The work terminal 1 includes a communication part 11, a controller 12, a memory 13, an input part 14, a camera 15, a microphone 16, a speaker 17, a display part 18, and a sensor 19. The work terminal 1 is an example of an information processing device.

The controller 12 controls the entire work terminal 1. The controller 12 controls operations of the communication part 11, the memory 13, the input part 14, the camera 15, the microphone 16, the speaker 17, the display part 18, and the sensor 19.

The memory 13 is, for example, a storage device, such as a random access memory (RAM), a solid state drive (SSD), or a flash memory, capable of storing various types of information.

The camera 15 acquires a moving image by capturing an image of the work site. In a case where the work terminal 1 is a wearable device worn on the head of the worker, the moving image is a moving image viewed from the viewpoint of the worker.

The microphone 16 collects the first voice at the work site.

The communication part 11 transmits the moving image captured by the camera 15 and the first voice collected by the microphone 16 to the server 2. In addition, the communication part 11 receives, from the server 2, the second voice around the assistance terminal 3 used by the assisting person at the remote place. In addition, the communication part 11 receives assistance information necessary for supporting the work performed by the worker at the work site from the assistance terminal 3 used by the assisting person who assists the work. In the present embodiment, the assistance information is a still image extracted by the assisting person from the moving image in the assistance terminal 3.

In the present embodiment, the work terminal 1 and the assistance terminal 3 transmit and receive various types of information to and from each other via the server 2, but the present disclosure is not particularly limited thereto, and the work terminal 1 and the assistance terminal 3 may transmit and receive various types of information to and from each other without the server 2.

The input part 14 receives various input operations by the worker. The input part 14 includes a first start button for starting photographing by the camera 15 and starting collection of the first voice by the microphone 16. Furthermore, the input part 14 includes a first end button for ending the photographing by the camera 15 and ending the collection of the first voice by the microphone 16. When the first start button is pressed by the worker, the camera 15 starts photographing, and the microphone 16 starts collecting the first voice. Further, when the first end button is pressed by the worker, the camera 15 ends photographing, and the microphone 16 ends collecting the first voice.

Furthermore, the input part 14 includes a second start button for starting transmission of the moving image and the voice to the server 2. Furthermore, the input part 14 includes a second end button for ending transmission of the moving image and the voice to the server 2. When the worker presses the second start button, the communication part 11 starts transmitting the moving image and the first voice to the server 2. When the worker presses the second end button, the communication part 11 ends transmitting the moving image and the first voice to the server 2.

The speaker 17 outputs the second voice received by the communication part 11 to the outside. The second voice includes the voice of the assisting person, and the worker can perform work while listening to the voice of the assisting person output from the speaker 17.

The controller 12 acquires a moving image captured at the work site from the camera 15. The controller 12 displays the assistance information received by the communication part 11 and the moving image acquired from the camera 15 on the display part 18. In the present embodiment, the controller 12 displays the still image received by the communication part 11 and the moving image acquired from the camera 15 on the display part 18.

The display part 18 displays the assistance information received by the communication part 11 and the moving image captured by the camera 15. In the present embodiment, the display part 18 displays the still image received by the communication part 11 and the moving image captured by the camera 15.

By displaying the still image, the worker can receive work assistance from the assisting person while viewing the still image extracted by the assisting person from the moving image. In addition, the display part 18 displays a still image on which characters and symbols are superimposed by the assisting person. As a result, the worker can receive more detailed work assistance from the assisting person while viewing the still image on which the characters and the symbols are superimposed. Note that the work terminal 1 may include a touch panel in which the input part 14 and the display part 18 are integrated.

Note that the controller 12 may individually display a still image (assistance information) and a moving image. Furthermore, the controller 12 may display a still image (assistance information) larger than a moving image. As a result, the worker can easily recognize the still image (assistance information), and can easily receive work assistance from the assisting person. In addition, sizes of a still image (assistance information) and a moving image to be displayed may be the same.

The sensor 19 measures an amount of change in motion of the worker. The sensor 19 includes, for example, a gyro sensor and an acceleration sensor. The gyro sensor measures a first angular velocity about the X axis (roll) indicating the front-back direction of the worker, a second angular velocity about the Y axis (pitch) indicating the left-right direction of the worker, and a third angular velocity about the Z axis (yaw) indicating the up-down direction of the worker. The acceleration sensor measures a first acceleration in the X-axis direction, a second acceleration in the Y-axis direction, and a third acceleration in the Z-axis direction.

The controller 12 acquires the amount of change in motion of the worker from the sensor 19. The controller 12 acquires at least one of the first angular velocity, the second angular velocity, the third angular velocity, the first acceleration, the second acceleration, and the third acceleration.

In a case where the camera 15 is mounted on the head of the worker, the sensor 19 preferably measures the amount of change in motion of the head of the worker. In this case, the controller 12 preferably acquires the amount of change in motion of the head of the worker from the sensor 19.

In a case where the amount of change acquired from the sensor 19 is equal to or larger than the threshold value, the controller 12 enlarges the displayed moving image. In a case where at least one of the first angular velocity, the second angular velocity, the third angular velocity, the first acceleration, the second acceleration, and the third acceleration is equal to or larger than a threshold value, the controller 12 enlarges the displayed moving image.

That is, the worker wearing the work terminal 1 on the head looks around in a case where the worker cannot accurately recognize which part of the work site the camera 15 is capturing even when viewing the moving image displayed on the display part 18. In a case where the amount of change in motion of the worker measured by the sensor 19 is equal to or larger than the threshold value, the controller 12 determines that the worker is looking around without accurately knowing which part of the work site the camera 15 is capturing. Then, the displayed moving image is enlarged, so that the worker can recognize the portion captured by the camera 15.

Note that the sensor 19 may include only a gyro sensor, and may measure only the first angular velocity, the second angular velocity, and the third angular velocity. In this case, the controller 12 may acquire at least one of the first angular velocity, the second angular velocity, and the third angular velocity. In a case where at least one of the first angular velocity, the second angular velocity, and the third angular velocity is equal to or larger than a threshold value, the controller 12 may enlarge the displayed moving image. In particular, in a case where the second angular velocity and the third angular velocity are equal to or larger than the threshold value, the controller 12 may enlarge the displayed moving image.

Furthermore, after enlarging the moving image, in a case where the amount of change acquired from the sensor 19 becomes smaller than the threshold value, the controller 12 returns the size of the moving image to be displayed to the original size.

Furthermore, in a case where the amount of change acquired from the sensor 19 is equal to or larger than the threshold value, the controller 12 may make the size of the displayed moving image larger than the size of the still image (assistance information).

Furthermore, in a case where the amount of change acquired from the sensor 19 is equal to or larger than the threshold value, the controller 12 only needs to make the size of the displayed moving image larger than the size of the current moving image, and does not necessarily need to make the size of the moving image larger than the size of the still image (assistance information).

In addition, at least one of the input part 14, the camera 15, the microphone 16, the speaker 17, the display part 18, and the sensor 19 may be provided outside the work terminal 1. For example, the work terminal 1 includes the communication part 11, the controller 12, and the memory 13, and may be communicably connected to the input part 14, the camera 15, the microphone 16, the speaker 17, the display part 18, and the sensor 19 provided outside. The camera 15 and the sensor 19 are mounted on the head of the worker.

The server 2 includes at least a computer system including, for example, a control program, a processing circuit such as a processor or a logic circuit that executes the control program, and a recording device such as an internal memory or an accessible external memory that stores the control program. Note that the server 2 may be implemented by, for example, hardware implementation by a processing circuit, execution of a software program held in a memory by the processing circuit or distributed from an external server, or a combination of the hardware implementation and the software implementation.

The server 2 is communicably connected to each of the work terminal 1 and the assistance terminal 3 via the network 4.

The server 2 includes a communication part 21, a controller 22, and a memory 23.

The communication part 21 receives a moving image captured at the work site and the first voice collected at the work site from the work terminal 1. In addition, the communication part 21 receives, from the assistance terminal 3, the assistance information necessary for supporting the work performed by the worker at the work site and the second voice around the assistance terminal 3. In addition, the communication part 21 transmits the moving image and the first voice received from the work terminal 1 to the assistance terminal 3. The communication part 21 also transmits the assistance information and the second voice received from the assistance terminal 3 to the work terminal 1.

The controller 22 controls the entire server 2. The controller 22 controls the operations of the communication part 21 and the memory 23. The controller 22 may record the moving image and the first voice received by the communication part 21 in the memory 23.

Note that the controller 22 may not only record the moving image and the first voice from the work terminal 1 in the memory 23, but also may record the moving image and the first voice from the work terminal 1 and the second voice from the assistance terminal 3 in the memory 23.

In addition, the controller 22 may record the moving image and the first voice from the work terminal 1 and the second voice and the still image (assistance information) from the assistance terminal 3 in the memory 23.

The communication part 21 may receive, from the assistance terminal 3 used by the assisting person, a recording start signal instructing to start recording based on an input operation by the assisting person at a remote place. In a case where the communication part 21 receives the recording start signal, the controller 22 may start recording the moving image and the first voice in the memory 23. Furthermore, the communication part 21 may receive, from the assistance terminal 3 used by the assisting person, a recording end signal instructing end of recording based on an input operation by the assisting person at a remote place. In a case where the communication part 21 receives the recording end signal, the controller 22 may end the recording of the moving image and the first voice in the memory 23.

Furthermore, in a case where a still image is received, the controller 22 may start recording of the moving image, the first voice, the second voice, and the still image received by the communication part 21 in the memory 23. Furthermore, in a case where the controller 22 no longer receives the still image while recording the moving image, the first voice, the second voice, and the still image, the controller 22 may end the recording of the moving image, the first voice, the second voice, and the still image received by the communication part 21 in the memory 23.

The memory 23 is a storage device, such as a random access memory (RAM), a hard disk drive (HDD), a solid state drive (SSD), or a flash memory, capable of storing various types of information. The memory 23 may non-transitorily record the moving image and the first voice from the work terminal 1.

In addition, the memory 23 may non-transitorily record not only the moving image and the first voice from the work terminal 1 but also the moving image and the first voice from the work terminal 1 and the second voice from the assistance terminal 3. That is, the memory 23 may non-transitorily record the moving image, the first voice, and the second voice received by the communication part 21. In this case, the memory 23 records the moving image, the first voice, and the second voice in one file. In addition, the memory 23 may non-transitorily record the moving image and the first voice from the work terminal 1 and the still image and the second voice from the assistance terminal 3.

The assistance terminal 3 is, for example, a personal computer, a smartphone, or a tablet computer.

The assistance terminal 3 includes at least a computer system including, for example, a control program, a processing circuit such as a processor or a logic circuit that executes the control program, and a recording device such as an internal memory or an accessible external memory that stores the control program. Note that the assistance terminal 3 may be implemented by, for example, hardware implementation by a processing circuit, execution of a software program held in a memory by the processing circuit or distributed from an external server, or a combination of the hardware implementation and the software implementation.

The assistance terminal 3 is communicably connected to the server 2 via the network 4.

The assistance terminal 3 includes a communication part 31, a controller 32, a memory 33, a display part 34, a speaker 35, a microphone 36, and an input part 37.

The microphone 36 collects the second voice around the assistance terminal 3.

The communication part 31 receives, from the server 2, the moving image captured at the work site and the first voice collected at the work site. In addition, the communication part 31 transmits the second voice around the assistance terminal 3 collected by the microphone 36 to the server 2.

Furthermore, the communication part 31 may transmit, to the server 2, a recording start signal instructing start of recording based on an input operation by an assisting person. Furthermore, the communication part 21 may transmit, to the server 2, a recording end signal instructing end of recording based on an input operation by an assisting person.

The controller 32 controls the entire assistance terminal 3. The controller 32 controls operations of the communication part 31, the memory 33, the display part 34, the speaker 35, the microphone 36, and the input part 37.

The memory 33 is, for example, a storage device that can store various types of information, such as a RAM, an HDD, an SSD, or a flash memory.

The display part 34 is, for example, a liquid crystal display, and displays various types of information. The display part 34 displays a moving image which is obtained by photographing the work site and received by the communication part 31. The moving image displayed on the display part 34 is a moving image captured in real time. The assisting person can confirm the work of the worker at the work site by viewing the moving image displayed on the display part 34.

The speaker 35 outputs, to the outside, the first voice which is collected at the work site and received by the communication part 31. The first voice output from the speaker 35 is a voice collected in real time. The assisting person can support the work of the worker while listening to the worker's voice output from the speaker 35.

The input part 37 is, for example, a keyboard, a mouse, or a touch panel. The input part 37 receives various input operations by the assisting person. The input part 37 includes a capture start button for extracting a still image from the moving image displayed by the display part 34. Note that the capture start button may be a button physically pressed by the assisting person or may be a button displayed on the display part 34 and clicked by the mouse.

The controller 32 determines whether the capture start button has been pressed. When the capture start button is pressed by the assisting person, the controller 32 extracts a still image from the moving image. The display part 34 displays the still image extracted from the moving image, and the communication part 31 periodically transmits the still image extracted from the moving image to the work terminal 1 via the server 2. For example, the assisting person presses the capture start button when there is a portion requiring support while viewing the moving image. As a result, the still image at the time when the capture start button is pressed is displayed on the display part 34, and is periodically transmitted to the work terminal 1 via the server 2 by the communication part 31.

In addition, the input part 37 receives an input of instruction information such as characters and symbols by the assisting person with respect to the still image displayed on the display part 34. For example, the assisting person draws an arrow or writes a character on the displayed still image in order to instruct specific work. The communication part 31 periodically transmits the still image on which the instruction information input by the assisting person is superimposed to the work terminal 1 via the server 2.

In addition, the input part 37 includes a capture end button for ending display and transmission of the extracted still image. Note that the capture end button may be a button physically pressed by the assisting person or may be a button displayed on the display part 34 and clicked by the mouse.

The controller 32 determines whether the capture end button has been pressed. When the capture end button is pressed by the assisting person, the display part 34 ends the display of the still image, and the communication part 31 ends the transmission of the still image to the server 2.

Furthermore, the input part 37 may include a recording start button for starting recording of the moving image and the first voice in the server 2. Note that the recording start button may be a button physically pressed by the assisting person or may be a button displayed on the display part 34 and clicked by a mouse. When the recording start button is pressed by the assisting person, the communication part 31 may transmit a recording start signal instructing the start of recording to the server 2.

Furthermore, the input part 37 may include a recording end button for ending the recording of the moving image and the first voice to the server 2. Note that the recording end button may be a button physically pressed by the assisting person or may be a button displayed on the display part 34 and clicked by a mouse. When the recording end button is pressed by the assisting person, the communication part 31 may transmit a recording end signal instructing end of recording to the server 2.

Note that any one of the work terminal 1, the server 2, and the assistance terminal 3 generates a communication ID before starting communication with each other, and transmits the generated communication ID to each of the work terminal 1, the server 2, and the assistance terminal 3. The work terminal 1, the server 2, and the assistance terminal 3 transmit and receive the moving image, the first voice, and the second voice using the communication ID. The communication ID is used to specify the moving image, the first voice, and the second voice.

Next, work assistance processing by each of the work terminal 1, the server 2, and the assistance terminal 3 in the first embodiment of the present disclosure will be described.

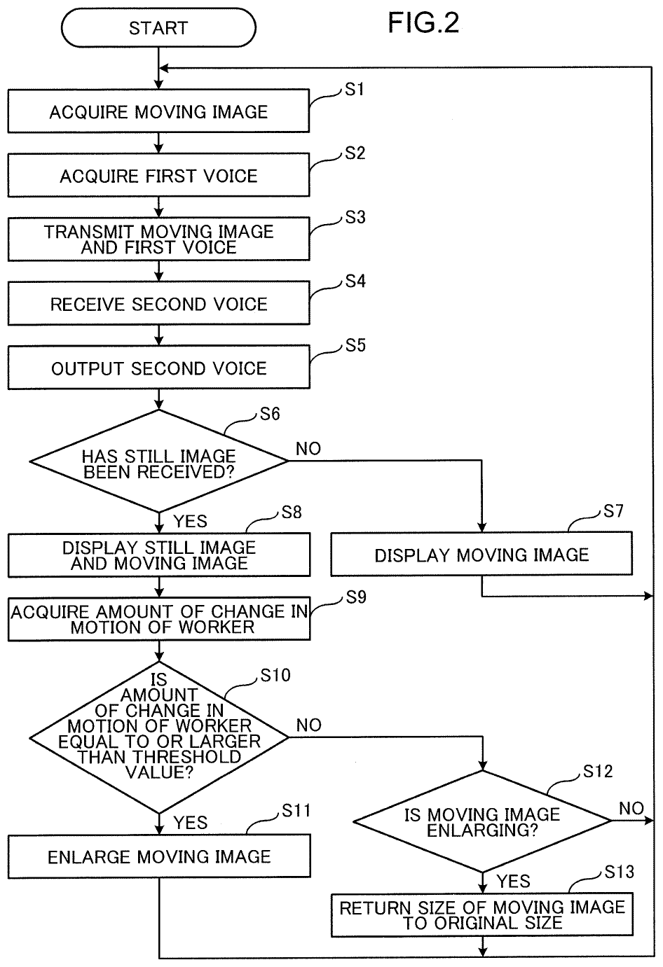

FIG. 2 is a flowchart for explaining work assistance processing by the work terminal 1 according to the embodiment of the present disclosure.

First, in step S1, the camera 15 acquires a moving image by photographing the work site. The camera 15 outputs a photographed moving image to the controller 12. The controller 12 acquires the moving image photographed by the camera 15. At this time, the input part 14 receives an input operation by the worker for starting acquisition of the moving image and the first voice.

Next, in step S2, the microphone 16 acquires the first voice at the work site. The microphone 16 outputs the acquired first voice to the controller 12. The controller 12 acquires the first voice acquired by the microphone 16.

Next, in step S3, the communication part 11 transmits the moving image acquired by the camera 15 and the first voice acquired by the microphone 16 to the server 2. At this time, the input part 14 receives an input operation by the worker for starting transmission of the moving image and the first voice. Furthermore, the communication part 11 transmits the moving image and the first voice to the server 2 with the assistance terminal 3 as a destination. As a result, the moving image and the first voice are transmitted to the assistance terminal 3 via the server 2.

Next, in step S4, the communication part 11 receives the second voice around the assistance terminal 3 transmitted by the server 2.

Next, in step S5, the speaker 17 outputs the second voice received by the communication part 11 to the outside.

Next, in step S6, the controller 12 determines whether a still image has been received by the communication part 11. The communication part 11 receives the still image transmitted by the server 2.

Here, in a case where it is determined that a still image has not been received (NO in step S6), the display part 18 displays a moving image captured by the camera 15 in step S7. At this time, the display part 18 displays the moving image on the entire screen. Then, the process returns to step S1. Note that, in a case where it is determined that a still image has not been received while a still image is being displayed, the display part 18 ends the display of the still image and displays only a moving image.

On the other hand, in a case where it is determined that a still image has been received (YES in step S6), in step S8, the display part 18 displays the still image received by the communication part 11 and the moving image captured by the camera 15.

Next, in step S9, the controller 12 acquires the amount of change in motion of the worker measured by the sensor 19. The sensor 19 measures the amount of change in motion of the worker and outputs the amount of change to the controller 12.

Next, in step S10, the controller 12 determines whether the amount of change in motion of the worker is equal to or larger than a threshold value. Here, in a case where it is determined that the amount of change in motion of the worker is equal to or larger than the threshold value (YES in step S10), the controller 12 enlarges the moving image displayed on the display part 18 in step S11. The display part 18 displays the enlarged moving image. Then, the process returns to step S1. At this time, the controller 12 may display the moving image larger than the still image (assistance information). Furthermore, the controller 12 may display only the moving image on the entire screen.

On the other hand, in a case where it is determined that the amount of change in motion of the worker is smaller than the threshold value (NO in step S10), the controller 12 determines whether the moving image is being enlarged in step S12. Here, in a case where it is determined that the moving image is not being enlarged (NO in step S12), the process returns to step S1.

On the other hand, in a case where it is determined that the moving image is being enlarged (YES in step S12), the controller 12 returns the size of the enlarged moving image to the original size in step S13. Then, the process returns to step S1.

In this manner, the assistance information necessary for supporting the work performed by the worker at the work site and the moving image acquired from the camera 15 are displayed on the display part 18, and in a case where the worker makes a motion to search for a portion captured by the camera 15, the displayed moving image is enlarged. Therefore, when the worker receives the work assistance from the assisting person, it is possible to cause the worker to recognize the portion captured by the camera 15.

Note that after the moving image is displayed in step S7, the controller 12 may determine whether to end the transmission of the moving image and the first voice. At this time, the input part 14 may receive an input operation by the worker to end the transmission of the moving image and the first voice. In a case where an input operation for ending the transmission of the moving image and the first voice is received, the controller 12 may determine to end the transmission of the moving image and the first voice. Furthermore, in a case where the input operation for ending the transmission of the moving image and the first voice is not received, the controller 12 may determine not to end the transmission of the moving image and the first voice. Here, in a case where it is determined that the transmission of the moving image and the first voice is to be ended, the work assistance processing may be ended. At this time, the communication part 11 may end the transmission of the moving image and the first voice. After the transmission of the moving image and the first voice is completed, the input part 14 may receive an input operation by the worker to end the acquisition of the moving image and the first voice. On the other hand, in a case where it is determined that the transmission of the moving image and the first voice is not ended, the process may return to step S1.

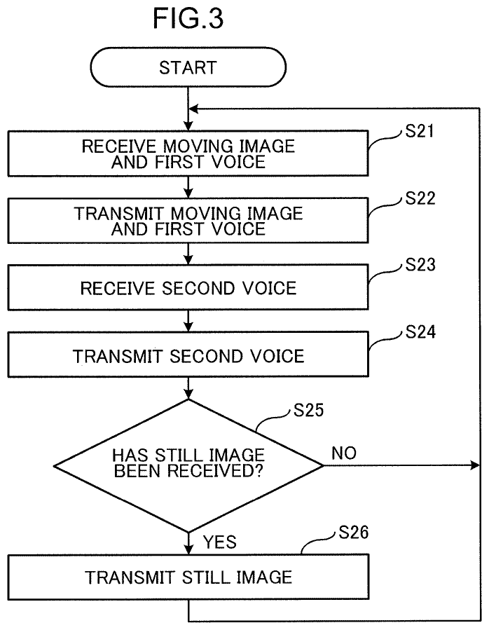

FIG. 3 is a flowchart for explaining work assistance processing by the server 2 according to the embodiment of the present disclosure.

First, in step S21, the communication part 21 receives the moving image and the first voice transmitted by the work terminal 1.

Next, in step S22, the communication part 21 transmits the received moving image and first voice to the assistance terminal 3.

Next, in step S23, the communication part 21 receives the second voice transmitted by the assistance terminal 3.

Next, in step S24, the communication part 21 transmits the received second voice to the work terminal 1.

Next, in step S25, the controller 22 determines whether a still image has been received by the communication part 21. The communication part 21 receives the still image transmitted by the assistance terminal 3.

Here, in a case where it is determined that a still image has been received (YES in step S25), in step S26, the communication part 21 transmits the received still image to the work terminal 1. Then, the process returns to step S21.

On the other hand, in a case where it is determined that the still image has not been received (NO in step S25), the process returns to step S21.

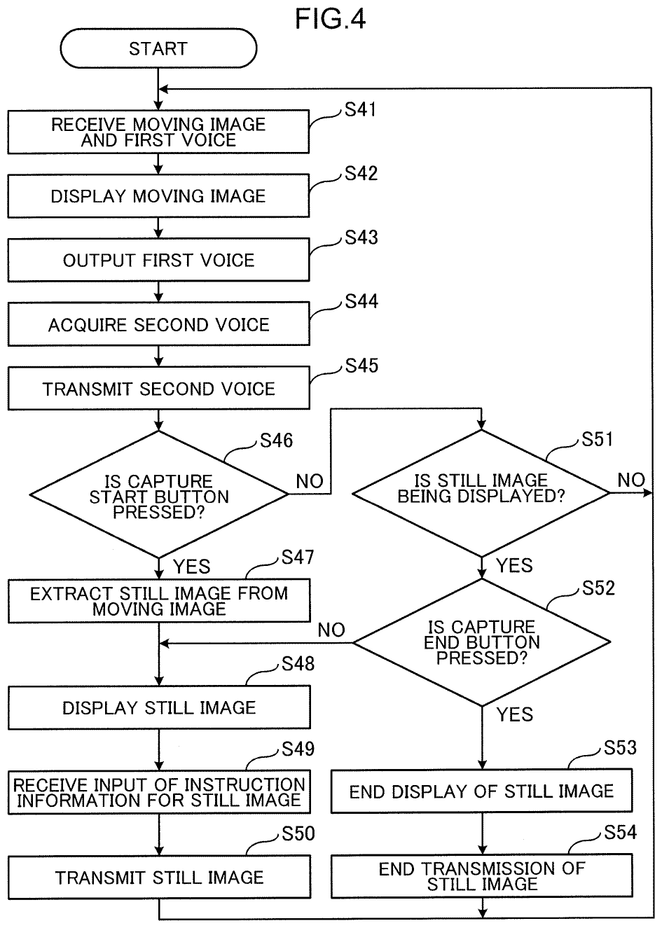

FIG. 4 is a flowchart for explaining work assistance processing by the assistance terminal 3 according to the embodiment of the present disclosure.

First, in step S41, the communication part 31 receives the moving image and the first voice transmitted by the server 2.

Next, in step S42, the display part 34 displays the moving image received by the communication part 31.

Next, in step S43, the speaker 35 outputs the first voice received by the communication part 31 to the outside.

Next, in step S44, the microphone 36 acquires the second voice around the assistance terminal 3.

Next, in step S45, the communication part 31 transmits the second voice acquired by the microphone 36 to the server 2. At this time, the communication part 31 transmits the second voice to the server 2 with the work terminal 1 as a destination. As a result, the second voice is transmitted to the work terminal 1 via the server 2.

Next, in step S46, the controller 32 determines whether the capture start button of the input part 37 has been pressed.

Here, in a case where it is determined that the capture start button has been pressed (YES in step S46), in step S47, the controller 32 extracts a still image from the moving image received by the communication part 31.

Next, in step S48, the display part 34 displays the still image extracted by the controller 32.

Next, in step S49, the input part 37 receives an input of instruction information such as characters and symbols by the assisting person for the still image displayed on the display part 34.

Next, in step S50, the communication part 31 transmits the still image extracted from the moving image to the server 2. Then, the process returns to step S41. In a case where instruction information such as characters and symbols is input by the assisting person, the communication part 31 transmits, to the server 2, a still image on which the instruction information is superimposed. In addition, the communication part 31 transmits the still image to the server 2 with the work terminal 1 as a destination. As a result, the still image is transmitted to the work terminal 1 via the server 2. In addition, during a period from when the capture start button is pressed until the capture end button is pressed, the still image is continuously transmitted to the work terminal 1 via the server 2.

On the other hand, in a case where it is determined that the capture start button has not been pressed (NO in step S46), in step S51, the controller 32 determines whether a still image is being displayed on the display part 34.

Here, in a case where it is determined that the still image is not being displayed (NO in step S51), the process returns to step S41.

On the other hand, in a case where it is determined that the still image is being displayed (YES in step S51), in step S52, the controller 32 determines whether the capture end button of the input part 37 has been pressed.

Here, in a case where it is determined that the capture end button has not been pressed (NO in step S52), the process proceeds to step S48.

On the other hand, in a case where it is determined that the capture end button has been pressed (YES in step S52), the display part 34 ends the display of the still image in step S53.

Next, in step S54, the communication part 31 ends the transmission of the still image to the server 2.

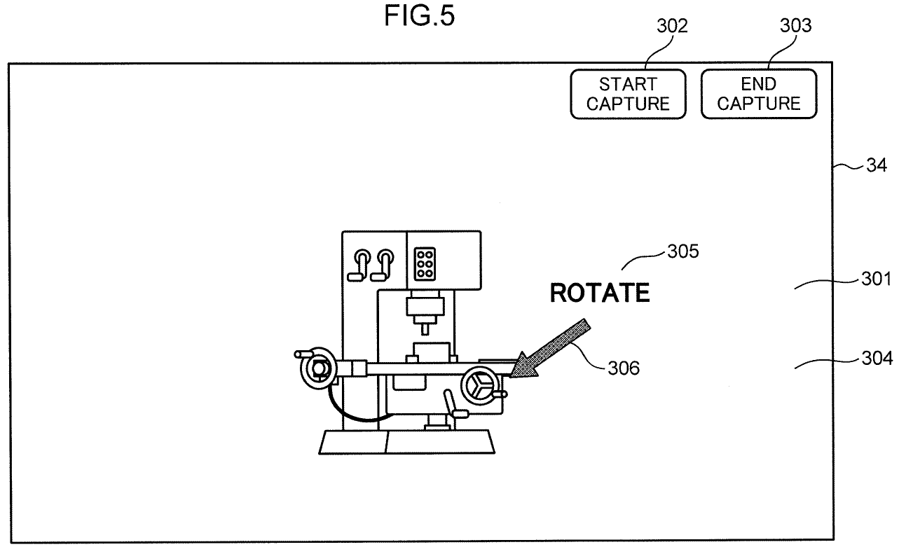

FIG. 5 is a diagram illustrating an example of the screen displayed on the display part 34 of the assistance terminal 3 in the present embodiment.

The display part 34 displays a moving image 301 obtained by photographing the work site, a capture start button 302, and a capture end button 303. When the pointer displayed on the display part 34 is moved onto the capture start button 302 by the operation of the mouse by the assisting person and the mouse button is clicked by the assisting person, a still image 304 is extracted from the moving image 301, and the extracted still image 304 is displayed on the display part 34. Then, the extracted still image 304 is transmitted to the server 2. The server 2 transmits the received still image 304 to the work terminal 1.

In addition, during the display of the still image 304, the pointer displayed on the display part 34 is moved onto the capture end button 303 by the operation of the mouse by the assisting person, and when the mouse button is clicked by the assisting person, the display of the still image 304 ends and the transmission of the still image 304 ends. As a result, the server 2 ends the transmission of the still image to the work terminal 1. When the display of the still image 304 ends, the display part 34 displays the moving image 301.

In addition, the input part 37 receives an input of instruction information such as characters 305 and a symbol 306 by the assisting person with respect to the still image 304 displayed on the display part 34. The assisting person writes the characters 305 and the symbol 306 in the still image 304 displayed on the display part 34 using a mouse or a keyboard. In FIG. 5, the characters 305 “ROTATE” and the symbol 306 representing an arrow are written. When the instruction information is input, the communication part 31 transmits, to the server 2, the still image 304 on which the instruction information is superimposed.

Note that, in the example of FIG. 5, in a case where the capture start button 302 is pressed, the display part 34 displays only the still image 304, but the present disclosure is not particularly limited thereto. The display part 34 may display an image by superimposing the moving image 301 on the still image 304. For example, the display part 34 may display the still image 304 on the entire screen and display the moving image 301 in a small size in the lower right portion of the screen.

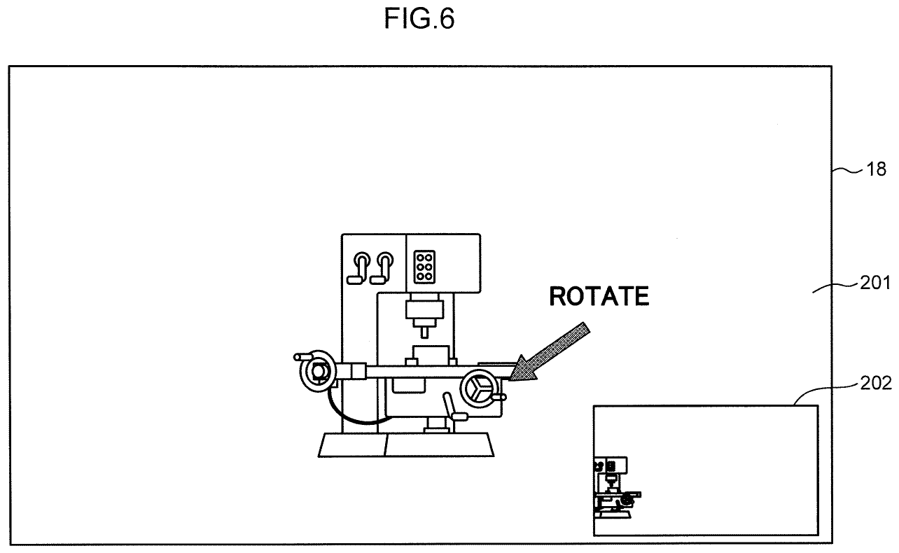

FIG. 6 is a diagram illustrating an example of a screen displayed on the display part 18 of the work terminal 1 in a case where a still image is received in the present embodiment.

In a case where the still image is received, the display part 18 displays a still image 201 transmitted by the assistance terminal 3 and a moving image 202 capturing the work site. The still image 201 is an image transmitted in real time by the assistance terminal 3. The moving image 202 is a moving image captured in real time by the camera 15. The display part 18 displays the still image 201 on the entire screen, and displays the moving image 202 in a small size in a lower right portion of the screen. In a case where instruction information is input to the still image 201, the still image 201 on which the instruction information is superimposed is displayed. The worker can receive assistance from the assisting person by performing work while viewing the still image 201 displayed on the display part 18.

In this way, in a case where the moving image 202 is displayed small, it is difficult for the worker to recognize where the camera 15 is capturing even if the worker views the moving image 202. For example, even if the assisting person issues an instruction “photograph the part X”, the worker does not know whether the camera 15 images the part X and looks around. In a case where the work terminal 1 is attached to the head, the worker looks around, and the amount of change in motion of the worker measured by the sensor 19 becomes equal to or larger than the threshold value.

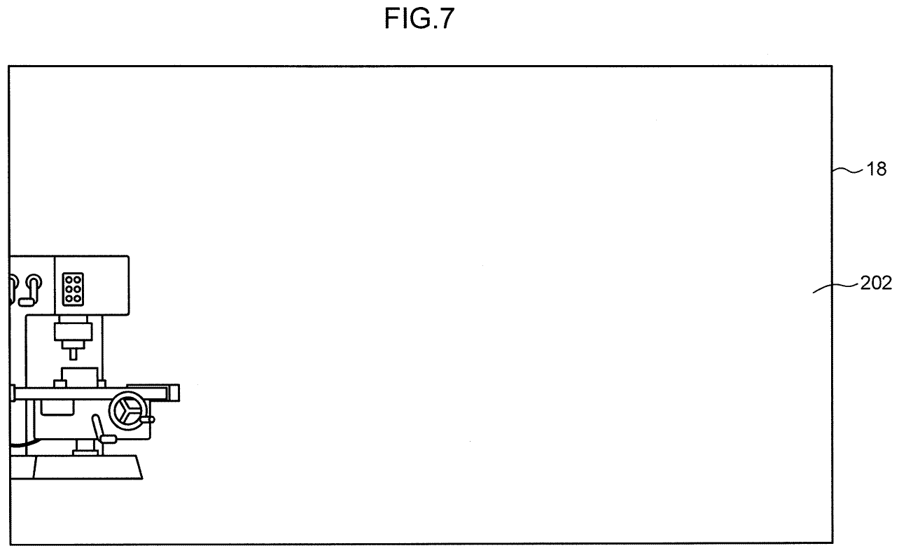

FIG. 7 is a diagram illustrating an example of a screen displayed on the display part 18 of the work terminal 1 in a case where it is determined that the amount of change in motion of the worker is equal to or larger than the threshold value in the present embodiment.

In a case where it is determined that the amount of change in motion of the worker is equal to or larger than the threshold value, the controller 12 enlarges the moving image 202 captured by the camera 15. In FIG. 7, the moving image 202 is displayed on the entire screen of the display part 18.

As a result, the worker can accurately recognize where the camera 15 is capturing, and can capture a moving image according to an instruction of the assisting person.

In the present embodiment, the assistance information for supporting the work performed by the worker at the work site is a still image extracted by the assisting person from the moving image in the assistance terminal 3, but the present disclosure is not particularly limited thereto. The assistance information may be drawing data of a work target. The drawing data is created by, for example, CAD (Computer Aided Design). The assistance information may be operation manual data indicating an operation method of the work target. Further, the assistance information may be an image of the entire screen displayed on the display part 34 of the assistance terminal 3. In this case, the assisting person may display information necessary for supporting the work on the display part 34 of the assistance terminal 3 and create an image obtained by copying the entire screen.

In a case where at least one of the first angular velocity, the second angular velocity, and the third angular velocity is equal to or larger than a first threshold value and the first acceleration, the second acceleration, and the third acceleration are smaller than a second threshold value, the controller 12 may enlarge the displayed moving image to a first size. Furthermore, in a case where at least one of the first angular velocity, the second angular velocity, and the third angular velocity is equal to or larger than the first threshold value, and at least one of the first acceleration, the second acceleration, and the third acceleration is equal to or larger than the second threshold value, the controller 12 may enlarge the displayed moving image to a second size larger than the first size.

That is, in a case where the worker moves the work terminal 1 in the direction around the X axis, the direction around the Y axis, or the direction around the Z axis without knowing the portion photographed by the camera 15, at least one of the first angular velocity, the second angular velocity, and the third angular velocity changes largely, but the first acceleration, the second acceleration, and the third acceleration do not change substantially. On the other hand, only in a case where the worker moves the work terminal 1 in the direction around the X axis, the Y axis, or the Z axis, the place where the camera 15 is capturing an image is not known. Further, in a case where the worker moves the work terminal 1 in the direction of the X axis, the Y axis, or the Z axis, at least one of the first angular velocity, the second angular velocity, and the third angular velocity changes greatly, and at least one of the first acceleration, the second acceleration, and the third acceleration also changes greatly. As described above, by changing the size of the moving image to be displayed according to the motion of the worker, it is possible to present the portion captured by the camera 15 to the worker in an easy-to-understand manner.

In a case where the amount of change in motion of the worker is equal to or larger than the threshold value, the controller 12 may change the size of the displayed moving image according to the magnitude of the difference value between the amount of change and the threshold value. That is, the size of the displayed moving image may increase as the difference value between the amount of change and the threshold value increases. By changing the size of the moving image to be displayed in stages according to the motion of the worker, it is possible to present a portion captured by the camera 15 to the worker in an easy-to-understand manner.

Note that, in each of the above embodiments, each constituent element may be implemented by including dedicated hardware or by executing a software program suitable for each constituent element. Each constituent element may be implemented by a program execution part, such as a CPU or a processor, reading and executing a software program recorded in a recording medium such as a hard disk or a semiconductor memory. A program may be recorded onto a recording medium and transferred or transferred via a network, so that the program is performed by another independent computer system.

Some or all functions of the device according to the embodiment of the present disclosure are implemented as large scale integration (LSI), which is typically an integrated circuit. These may be individually integrated into one chip, or may be integrated into one chip so as to include some or all of these. Circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the device according to the embodiments of the present disclosure may be implemented by a processor such as a CPU executing a program.

All numbers used above are illustrated to specifically describe the present disclosure, and the present disclosure is not limited to the illustrated numbers.

The order in which steps illustrated in the above flowchart are executed is for specifically describing the present disclosure, and may be any order other than the above order as long as a similar effect is obtained. Some of the above steps may be executed simultaneously (in parallel) with other steps.

The technology according to the present disclosure is useful as a technology for displaying a moving image captured at a work site since the technology can cause a worker to recognize a portion captured by a camera when the worker receives work assistance from an assisting person.

1. An information processing method executed by a computer, the information processing method comprising:
acquiring a moving image captured at a work site from a camera;
receiving assistance information necessary for supporting work performed by a worker at the work site from an assistance terminal used by an assisting person who assists the work;
displaying the received assistance information and the acquired moving image on a display part;
acquiring an amount of change in motion of the worker from a sensor; and
enlarging the displayed moving image in a case where the amount of change is equal to or larger than a threshold value.

2. The information processing method according to claim 1, further comprising transmitting the acquired moving image to the assistance terminal,
wherein the assistance information is a still image extracted by the assisting person from the moving image in the assistance terminal.

3. The information processing method according to claim 1, wherein the assistance information is drawing data of a work target.

4. The information processing method according to claim 1, wherein the assistance information is operation manual data indicating an operation method of a work target.

5. The information processing method according to claim 1, wherein the assistance information is an image of an entire screen displayed on a display part of the assistance terminal.

6. The information processing method according to claim 1, further comprising returning a size of the displayed moving image to an original size in a case where the amount of change becomes smaller than the threshold value after the moving image is enlarged.

7. The information processing method according to claim 1, wherein the amount of change is at least one of a first angular velocity about an X axis indicating a front-back direction of the worker, a second angular velocity about a Y axis indicating a left-right direction of the worker, and a third angular velocity about a Z axis indicating an up-down direction of the worker.

8. The information processing method according to claim 1, wherein the amount of change is at least one of a first angular velocity about an X axis indicating a front-back direction of the worker, a second angular velocity about a Y axis indicating a left-right direction of the worker, a third angular velocity about a Z axis indicating an up-down direction of the worker, a first acceleration in the X-axis direction, a second acceleration in the Y-axis direction, and a third acceleration in the Z-axis direction.

9. The information processing method according to claim 8, wherein enlarging the moving image includes enlarging the displayed moving image to a first size in a case where at least one of the first angular velocity, the second angular velocity, and the third angular velocity is equal to or larger than a first threshold value and the first acceleration, the second acceleration, and the third acceleration are smaller than a second threshold value, and enlarging the displayed moving image to a second size larger than the first size in a case where at least one of the first angular velocity, the second angular velocity, and the third angular velocity is equal to or larger than the first threshold value and at least one of the first acceleration, the second acceleration, and the third acceleration is equal to or larger than the second threshold value.

10. The information processing method according to claim 1, wherein enlarging the moving image includes changing a size of the displayed moving image according to a magnitude of a difference value between the amount of change and a threshold value in a case where the amount of change is equal to or larger than the threshold value.

11. The information processing method according to claim 1, wherein the camera and the sensor are mounted on a head of the worker.

12. An information processing device comprising:
a communication part; and
a controller,
wherein the controller acquires a moving image captured at a work site from a camera,
the communication part receives assistance information necessary for assisting work performed by a worker at the work site from an assistance terminal used by an assisting person who assists the work,
the controller displays the received assistance information and the acquired moving image on a display part,
the controller acquires an amount of change in motion of the worker from a sensor, and
the controller enlarges the displayed moving image in a case where the amount of change is equal to or larger than a threshold value.

13. A non-transitory computer readable recording medium storing an information processing program for causing a computer to execute:
acquiring a moving image captured at a work site from a camera;
receiving assistance information necessary for assisting work performed by a worker at the work site from an assistance terminal used by an assisting person who assists the work;
displaying the received assistance information and the acquired moving image on a display part;
acquiring an amount of change in motion of the worker from a sensor; and
enlarging the displayed moving image in a case where the amount of change is equal to or larger than a threshold value.
